(19) United States
(12) Patent Application Publication
(10) Pub. No.: US 2018/0370273 A1
(43) Pub. Date: Dec. 27, 2018

(54) PROCESS FOR PROTECTING A DOCUMENT, PROTECTIVE DEVICE COMPRISING AN ADHESIVE LAYER AND DOCUMENT

(71) Applicant: FASVER, Baillargues (FR)

(72) Inventors: Eric Philippe, Eyuieres (FR); Laurence Bes, Jacou (FR)

(73) Assignee: FASVER, Baillargues (FR)

(21) Appl. No.: 16/062,527

(22) PCT Filed: Dec. 15, 2016
(86) PCT No.: PCT/FR2016/053474

§ 371 Date: Jun. 14, 2018

(30) Foreign Application Priority Data
Dec. 16, 2015 (FR) 1562539

(51) Int. Cl. B42D 25/351; B42D 25/47; B42D 25/455

(52) U.S. Cl. CPC B42D 25/351; C09J 5/06; B42D 25/455; B42D 25/47

(57) ABSTRACT

The invention relates to a process for protecting variable inscriptions of a document in which: a transparent film is bonded to a face of said document with a view to protecting variable inscriptions of said document, by at least one adhesive layer comprising at least one thermoplastic polymer having a glass transition temperature between 40° C. and 110° C. and having a hydroxyl value between 3 mg of KOH/g and 60 mg of KOH/g and/or an acid value between 2 mg of KOH/g and 150 mg of KOH/g, said adhesive layer comprises a crosslinking agent having at least 2.8 functions selected from the group formed of isocyanates, carbodiimides, aziridines and alkoxysilanes, during the bonding, a crosslinking of said adhesive layer is carried out. The invention also relates to a protective device and to a document.

### CROSS-REFERENCE TO RELATED APPLICATIONS

This application claims priority to International PCT Patent Application PCT/FR2016/053474, which was filed on 15 Dec. 2016, and which claims priority to French Patent Application 1562539, which was filed on 16 Dec. 2015.

### FIELD

The invention relates to a process for protecting a document, in particular an official document. The invention also relates to a protective device comprising an adhesive layer and to a document, in particular an official document, comprising at least one such protective device.

### BACKGROUND

Official documents are documents which, owing to their nature and/or the rights that they may confer, must be protected against attempts at falsification and/or counterfeiting and/or in order to guarantee authentication and/or to guarantee their integrity (that is to say the fact that they have not been altered or modified). They may in particular be passports, visas, identity cards, driver's licenses, registration documents, loyalty cards, bank cards, bank checks, diplomas, certificates, transport documents, access control cards, badges, labels, legal writs, contracts, legal registers, cadastral maps, fiduciary documents, bank notes, manufacturing drawings or other drawings, etc. Official documents bear inscriptions, such as variable personalization information (surname, first name, address, photo, signature, etc. of a holder or of parties, etc.) and/or common information (security patterns, matrices, boxes, field names, seals, holograms, signatures, values, etc.).

Throughout the text, the term “inscription” denotes any sign or pattern made on a layer of a document, that can be read by man and/or by machine (OCR), at least under certain conditions (in particular under normal lighting with visible light; and/or under specific lighting; and/or after activation of an electronic device (screen) or the like, etc.). This may be in particular variable personalization information (name, public record, photograph, value, dates, etc.) of an official document or common and/or security information; texts (handwritten or printed characters); codes (ASCII, universal codes for optoelectronic reading, such as bar codes, QR codes, etc.); drawings, images or photographs; marks or flat tints, etc. Official documents generally contain inscriptions, termed security inscriptions, for preventing or making very complex their reproduction or their falsification. These security inscriptions may be of the type that are visible in the visible range by simple observation with the naked eye (first-level security); or of the type that can be inspected by means of a specific device, such as an ultraviolet ray lamp (second-level security); or of the type that can be tested only in a certified laboratory (third-level security).

Throughout the text, the expression “at least substantially” indicates, in the usual manner, that a structural or functional characteristic should not be taken as marking an abrupt discontinuity, which would make no physical sense, but covers not only this structure or this function, but also slight variations in this structure or in this function which produce, in the technical context in question, an effect of the same nature, if not of the same degree.

Numerous official documents, such as bank cards, identity cards, driver's licenses, cards for individual access to public sites or transport, passport pages, customs cards, visas, fiduciary documents, bank notes, etc. are made up of several layers assembled together, for example using an adhesive.

However, the presence of such an adhesive layer constitutes a weak point of said official documents in the face of the various methods of falsification, this being despite the presence of particular security elements in the layers forming the document. This is because most of the adhesives used that are compatible with such documents are often thermoplastic materials, having a temperature above which they soften. The adhesive properties of such thermoplastic adhesives increase with an increase in temperature, which allows the bonding. The layers assembled by such adhesives can therefore be separated at least by heating above a predetermined temperature. In addition, it is also possible to separate the various layers forming the document by dissolving the adhesive layer and/or the adjacent layers in solvents or else by mechanical sanding of the adjacent layers.

DE 10 2011 112 951 describes for example a security document and a hot-seal lacquer in which an encapsulated adhesive is used. However, it proves to be the case that the use of such a hot-seal composition does not make it possible to obtain satisfactory results in terms of manufacture (a need to choose a particular adhesive, a need for heating at a predetermined temperature, etc.), or in terms of anti-falsification, it remaining possible to falsify and detach the various layers assembled by heating.

### BRIEF DESCRIPTION

The invention therefore aims to overcome these drawbacks by providing a process for protecting a document, a protective device and a document which make it possible to protect variable inscriptions borne by said document.

The invention also aims to provide a process for protecting a document and a protective device which make it possible to protect said document against falsifications and/or for its authentication and/or for guaranteeing its integrity.

The invention aims more particularly to allow the production of a protective device that can be bonded, and in particular transferred, irreversibly onto a document, in particular an official document, said protective device having a strong adhesive power.

The invention also aims to provide a process for protecting a document and a protective device which make it possible to protect a document without giving it a stiffness that would not be desired and/or that would be greater or much greater than its initial stiffness.

The invention also aims to provide a process for protecting a document and a protective device which make it possible to protect a document against most of the known processes for falsifying official documents (in particular bringing into contact with a hotplate, soaking in hot water, soaking in solvents such as acetone or else White Spirit®, etc.).

To do this, the invention relates to a process for protecting a document, where a transparent film is bonded to a face of said document with a view to protecting variable inscriptions of said document, by at least one adhesive layer comprising at least one thermoplastic polymer. The thermoplastic polymer is chosen from the group made up of thermoplastic polymers having a hydroxyl number, measured according to the standard DIN 53 240/2, of between 3 mg of KOH/g and 60 mg of KOH/g (of said thermoplastic polymer), thermoplastic polymers having an acid number, measured according to the standard DIN EN ISO 2114, of between 2 mg of KOH/g and 150 mg of KOH/g (of said thermoplastic polymer), copolymers thereof and blends thereof. The thermoplastic polymer has a glass transition temperature, measured by differential scanning calorimetry, of between 40° C. and 110° C. The adhesive layer also comprises at least one crosslinking agent. Each crosslinking agent is chosen from the group of aliphatic compounds comprising between 4 and 50 carbon atoms, and has, on average, at least 2.8 functions, selected from the group made up of isocyanates, carbodiimides, aziridines and alkoxysilanes, per molecule of crosslinking agent. During the bonding of said transparent film to said document, crosslinking of said thermoplastic polymer and of said crosslinking agent is carried out, that is to say crosslinking of the adhesive layer, the crosslinking reaction being carried out between said thermoplastic polymer and said crosslinking agent.

The invention also relates to a protective device for a document having variable inscriptions to be protected. The protective device includes at least one transparent film bearing at least one adhesive layer comprising at least one thermoplastic polymer. The thermoplastic polymer is chosen from the group made up of thermoplastic polymers having a hydroxyl number, measured according to the standard DIN 53 240/2, of between 3 mg of KOH/g and 60 mg of KOH/g (of said thermoplastic polymer), thermoplastic polymers having an acid number, measured according to the standard DIN EN ISO 2114, of between 2 mg of KOH/g and 150 mg of KOH/g (of said thermoplastic polymer), copolymers thereof and blends thereof. The thermoplastic polymer has a glass transition temperature, measured by differential scanning calorimetry, of between 40° C. and 110° C., and in particular of between 50° C. and 85° C. The adhesive layer also comprises at least one crosslinking agent. Each crosslinking agent is chosen from the group of aliphatic compounds comprising between 4 and 50 carbon atoms, and has, on average, at least 2.8 functions, chosen from the group made up of isocyanates, carbodiimides, aziridines and alkoxysilanes, per molecule of crosslinking agent.

The invention also relates to a protective device for carrying out a process for protecting a document according to the invention.

The invention also relates to a document comprising a base sheet, variable inscriptions associated with said base sheet and at least one protective device according to the invention.

The inventors have noted that the choice of an adhesive layer comprising such a thermoplastic polymer and such a crosslinking agent makes it possible, after they have been crosslinked together, during the bonding of said transparent film to a document, to obtain a very strong bonding and a document that is efficiently protected against any type of falsification. A protecting process and a protective device according to the invention therefore make it possible to guarantee the authenticity and the integrity of a document by protecting the layers arranged under said transparent film, while at the same time preserving the initial flexibility and the initial transparency of the document, the adhesive layer not affecting this transparency (at least in the visible range).

This is entirely surprising and goes against the properties of known adhesives. Indeed, to overcome the falsification problems associated with the use of thermoplastic adhesives, it might have been thought that it was sufficient to use conventional thermosetting adhesives. However, the inventors have noted that the use of known thermosetting adhesives is very unsatisfactory and results in embrittlement of the document to be protected and too weak a resistance to delamination. In addition, thermosetting adhesives do not make it possible to preserve the transparency of a document. Entirely surprisingly, the inventors have noted that, by crosslinking an adhesive comprising at least one such thermoplastic polymer and at least one such crosslinking agent, it is possible to prepare a protective device and a document with which exceptional results are obtained in terms of bonding, in particular with regard to the delamination resistance of the transparent film and of the document.

The invention also relates to a process for protecting a document, where a protective device is bonded to a face of said document with a view to protecting variable inscriptions of said document. At least one protective device comprising at least one adhesive layer comprising at least one thermoplastic polymer is placed on said document. The adhesive layer extends in contact with an extreme layer of a transparent film. The thermoplastic polymer is chosen from the group made up of thermoplastic polymers having a hydroxyl number, measured according to the standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof. The thermoplastic polymer has a glass transition temperature, measured by differential scanning calorimetry, of between 40° C. and 110° C., and in particular between 50° C. and 85° C. The adhesive layer also comprises at least one crosslinking agent. Each crosslinking agent is chosen from the group of aliphatic compounds comprising between 4 and 50 carbon atoms, and in particular between 4 and 46 carbon atoms, and has, on average, at least 2.8 functions, chosen from the group made up of isocyanates, carbodiimides, aziridines and alkoxysilanes, per molecule of crosslinking agent. During the bonding of said protective device to said document, crosslinking of said thermoplastic polymer and of said crosslinking agent is carried out.

The invention also relates to a protective device for a document having variable inscriptions to be protected. The protective device includes at least one adhesive layer comprising at least one thermoplastic polymer, said adhesive layer extending in contact with an extreme layer of a transparent film. The thermoplastic polymer is chosen from the group made up of thermoplastic polymers having a hydroxyl number, measured according to the standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof. The thermoplastic polymer has a glass transition temperature, measured by differential scanning calorimetry, of between 40° C. and 110° C., and in particular of between 50° C. and 85° C. The adhesive layer also comprises at least one crosslinking agent. Each crosslinking agent is chosen from the group of aliphatic compounds comprising between 4 and 50 carbon atoms, and has, on average at least 2.8 functions, chosen from the group made up of isocyanates, carbodiimides, aziridines and alkoxysilanes, per molecule of crosslinking agent.

The invention also relates to a document comprising a base sheet, variable inscriptions associated with said base sheet, and at least one adhesive layer comprising at least one thermoplastic polymer, said adhesive layer extending in contact with an extreme layer of said base sheet. The thermoplastic polymer is chosen from the group made up of thermoplastic polymers having a hydroxyl number, measured according to the standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof. The thermoplastic polymer has a glass transition temperature, measured by differential scanning calorimetry, of between 40° C. and 110° C. The adhesive layer also comprises at least one crosslinking agent. Each crosslinking agent is chosen from the group of aliphatic compounds comprising between 4 and 50 carbon atoms, and has, on average, at least 2.8 functions, chosen from the group made up of isocyanates, carbodiimides, aziridines and alkoxysilanes, per molecule of crosslinking agent.

The invention relates in particular to a document obtained by means of a process for protecting a document according to the invention.

Any printing technique can be used to print said adhesive layer on the transparent film and/or the document, in particular chosen from screen printing, photogravure, flexography, offset printing, or the like.

Once the adhesive layer has been applied to the transparent film, the adhesive layer is suitable for allowing the bonding of the protective device to a document immediately after the preparation of the protective device (in particular after the application of the adhesive layer to the transparent film) or subsequently, in particular several days to several months after the depositing of the adhesive layer on the transparent film. This makes it possible to have a protective device able to be irreversibly bonded to a document while at the same time being able to choose the moment at which it is desired to carry out this bonding. In particular, the operator carrying out the bonding of the protective device to a document does not need to have devices for mixing at least two components, or to himself apply an adhesive, in particular in liquid form, but can trigger or activate the bonding himself at the desired moment, for example by passing under a heating lamination roll.

Once the adhesive layer has been placed in contact with a document to be protected, the reaction for crosslinking the adhesive layer can be activated in various ways.

In one advantageous embodiment of a process according to the invention, said reaction for crosslinking said adhesive layer is activated by subjecting said adhesive layer to a temperature suitable for allowing the crosslinking of said adhesive layer by reaction of the crosslinking agent in particular with the OH groups and/or the acid groups of the thermoplastic polymer. Advantageously and according to the invention, said crosslinking of said adhesive layer is carried out at a temperature of between 60° C. and 220° C., and in particular between 80° C. and 200° C.

In one advantageous embodiment of a process according to the invention, at least one step of hot lamination, under pressure, of said document, in particular of the document coated with said transparent film, and in particular of the document coated with said protective device, is carried out. This hot lamination can be carried out at a temperature between 60° C. and 220° C., and in particular between 80° C. and 200° C., it being possible for the crosslinking to in particular take place during this lamination step.

Advantageously and according to the invention, said transparent film comprises a plurality of superimposed layers. Advantageously and according to the invention, said transparent film is formed of layers of at least one material chosen from the group of thermoplastic materials. In particular, a transparent film used in a process and a protective device according to the invention can advantageously be formed by hot lamination, under pressure, of a plurality of layers of a thermoplastic material chosen from polycarbonates, PVC, blends thereof and combinations thereof.

Advantageously and according to the invention, said transparent film comprises at least one layer, in particular at least one thermoplastic extreme layer.

The protective device, and in particular the transparent film used, can comprise security inscriptions such as inscriptions prepared using photoluminescent pigments (chosen from fluorescent pigments and phosphorescent pigments), inscriptions prepared using iridescent pigments, reflective metalized inscriptions or else markings made by gravure and/or laser marking.

In some embodiments, advantageously and according to the invention, said protective device, in particular the transparent film and said adhesive layer, are transparent to wavelengths not only in the visible range, but also in the ultraviolet (long ultraviolet and/or short ultraviolet) range and/or infrared range. In particular, advantageously and according to the invention, said transparent film does not exhibit fluorescence when it is exposed to wavelengths in the ultraviolet range, in particular to wavelengths substantially equal to 354 nm. In particular, once bonded to a document, the protective device, and in particular the transparent film, remain transparent to wavelengths in the visible range, but also in the ultraviolet (long ultraviolet and/or short ultraviolet) range and/or infrared range, in such a way that the protected inscriptions remain visible (and readable), as do, for example, security inscriptions for authentication which are invisible but luminescent under UVA rays and/or UVC rays and/or under infrared rays.

In some embodiments, advantageously and according to the invention, said thermoplastic polymer included in the adhesive layer has a glass transition temperature, measured by differential scanning calorimetry, of between 50° C. and 85° C. and has a hydroxyl number of between 3 mg of KOH per gram of said thermoplastic polymer and 50 mg of KOH per gram of said thermoplastic polymer, and/or an acid number, measured according to the standard DIN EN ISO 2114, of between 3 mg of KOH per gram of said thermoplastic polymer and 50 mg of KOH per gram of said thermoplastic polymer.

Advantageously and according to the invention, the hydroxyl number of said thermoplastic polymer is measured according to the standard DIN 53 240/2 of November 2007. Advantageously and according to the invention, the hydroxyl number represents the weight of potassium hydroxide in milligrams that is required to neutralize the acid which combines by acylation with 1 gram of said thermoplastic polymer. The method for determining the hydroxyl number involves an acetylation of the free hydroxyl groups of said thermoplastic polymer with acetic anhydride (ethanoic anhydride) in a solvent such as pyridine. After this acetylation, water is added and the unreacted acetic anhydride is converted to acetic acid and measured by titration using potassium hydroxide.

Advantageously and according to the invention, the acid number of said thermoplastic polymer is measured according to the standard DIN EN ISO 2114 of November 2000 (or according to the standard DIN EN ISO 3682 of November 1996). Advantageously and according to the invention, the acid number represents the weight of potassium hydroxide in milligrams that is required to neutralize the free acids present in 1 gram of said thermoplastic polymer.

The inventors have noted that the use, on the one hand, of at least one thermoplastic polymer having such a hydroxyl number and/or such an acid number and, on the other hand, of at least one crosslinking agent having at least 2.8 functions chosen from the group made up of isocyanates, carbodiimides, aziridines and alkoxysilanes makes it possible to react said thermoplastic polymer and said crosslinking agent so as to obtain a very strong bond, the force of adhesion to a document being very high while at the same time making it possible to form a transparent adhesive layer, at least in the visible range and thus without affecting the transparency of the transparent film, or of the document to which the transparent film is applied.

In some embodiments, advantageously and according to the invention, said thermoplastic polymer is chosen from the group of thermoplastic polymers having, in particular before said crosslinking, a weight-average molecular weight, measured by size exclusion chromatography (SEC), of between 3000 g/mol and 65 000 g/mol. Indeed, the inventors have noted that these polymers, which are in particular different than the low-molecular-weight polyols sometimes used, make it possible to obtain better bonding while at the same time exhibiting mechanical properties that are satisfactory for the preparation of a document and of a protective device for such a document, in particular an official document.

In some embodiments, advantageously and according to the invention, said adhesive layer comprises at least one thermoplastic material chosen from the group made up of polyurethanes (PUs), polyesters, polyethers, polyacrylics, polyvinyl butyral, polyvinyl acetal, cellulose, copolymers thereof and blends thereof.

Each crosslinking agent is chosen from the group made up of aliphatic compounds comprising between 4 and 50 carbon atoms and has on average at least 2.8 functions (or an average functionality of at least 2.8) chosen from the group made up of isocyanates, carbodiimides, aziridines and alkoxysilanes, per molecule of crosslinking agent. In particular, this means that use is made of a composition, termed crosslinking composition, comprising at least one such crosslinking agent, each molecule of crosslinking agent of said crosslinking composition comprising on average at least 2.8 functions chosen from the group made up of isocyanates, carbodiimides, aziridines and alkoxysilanes (the standard deviation being low).

In some embodiments, advantageously and according to the invention, said crosslinking agent is chosen from the group made up of polyisocyanates, polycarbodiimides, polyaziridines and alkoxysilanes, said crosslinking agent having on average at least 2.8 functions chosen from the group made up of isocyanates, carbodiimides, aziridines and alkoxysilanes, per molecule of crosslinking agent. In some embodiments, advantageously and according to the invention, said crosslinking agent is chosen from the group made up of compounds having on average between 2.8 and 6 functions per molecule of crosslinking agent, and in particular between 2.8 and 3.5 (values included) functions chosen from the group made up of isocyanates, carbodiimides, aziridines and alkoxysilanes, per molecule of crosslinking agent.

Throughout the text, the term “functionality or average number of functions per molecule of crosslinking agent” is intended to mean the number f=Mₙ×C (f being equal to Mₙ multiplied by C), Mₙ representing the number-average molar mass of the crosslinking agent (measured by gel permeation chromatography) and C representing the concentration of isocyanate, carbodiimide, aziridine or alkoxysilane functions in moles per gram of crosslinking agent (that can be measured by indirect potentiometry or by means of another suitable titration method).

Throughout the text, the term “isocyanate function” is intended to mean any group of formula —N═C═O, the isocyanate function being bonded to the crosslinking agent by the nitrogen atom (N). Throughout the text, the term “carbodiimide function” is intended to mean the group of formula —N═C═N—, the carbodiimide function being bonded to the crosslinking agent by at least one of the nitrogen atoms (N).

Throughout the text, the term “aziridine function” is intended to mean any group of formula:

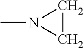

the aziridine function being bonded to the crosslinking agent by the nitrogen atom (N).

Throughout the text, the term “alkoxysilane function” is intended to mean any group of formula —Si—O—, the alkoxysilane function being bonded to the crosslinking agent by the silicon atom (Si) and/or the oxygen atom (O).

In some embodiments, advantageously and according to the invention, prior to said crosslinking reaction, said adhesive layer comprises 0.5% to 10% by weight of crosslinking agent relative to the total weight of said thermoplastic polymer, and in particular 1% to 5% by weight of crosslinking agent relative to the total weight of said thermoplastic polymer. A protective device according to the invention, and in particular said adhesive layer, thus comprises, before being affixed to a document to be protected, 0.5% to 10% by weight of crosslinking agent relative to the total weight of said thermoplastic polymer. This is because the inventors have noted that a low percentage of crosslinking agent is sufficient to make it possible to obtain excellent bonding of the transparent film to a document and that adding a higher proportion of crosslinking agent to said adhesive layer is, on the contrary, prejudicial to the obtaining of such bonding.

The crosslinking agent can be added in a liquid or solid form, directly by mixing with the thermoplastic material of the adhesive layer.

In some embodiments, advantageously and according to the invention, the adhesive layer is prepared and applied so as to form said adhesive layer using a composition, termed adhesive composition, comprising at least 10% by weight, and in particular 10% to 60% by weight (in particular when a solvent is also used to prepare the adhesive composition), of thermoplastic polymer relative to the total weight of said composition, said thermoplastic polymer being chosen from the group made up of thermoplastic polymers having a hydroxyl number, measured according to the standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof, and from the group made up of thermoplastic polymers having a glass transition temperature, measured by differential scanning calorimetry, between 40° C. and 110° C., and at least 0.5% by weight, and in particular 0.5 to 10% by weight, of crosslinking agent relative to the total weight of said composition, said crosslinking agent being chosen from the group made up of aliphatic compounds comprising between 4 and 50 carbon atoms, and from the group made up of compounds having on average at least 2.8 functions chosen from the group made up of isocyanates, carbodiimides, aziridines and alkoxysilanes, per molecule of crosslinking agent.

In particular, advantageously and according to the invention, such an adhesive composition also comprises one or more solvent(s) of said thermoplastic polymer, that is to say any liquid in which said thermoplastic polymer or said crosslinking agent is miscible or which can be used to dilute said thermoplastic polymer or said crosslinking agent. Any solvent suitable for being able to prepare such an adhesive composition also comprising said thermoplastic polymer and said crosslinking agent can be used.

In other variants according to the invention, the crosslinking agent and the thermoplastic material are not present in one and the same layer. A layer comprising the thermoplastic material can for example be applied to the transparent film, while a layer comprising the crosslinking agent and optionally a tie can be applied directly to the document to be protected, or conversely.

In one variant of implementation of a process according to the invention, the adhesive layer is deposited directly on the document to be protected, then the transparent film is applied in contact with the adhesive layer deposited on the document (it being possible for the transparent film to itself also be coated with an adhesive or non-adhesive layer).

The invention extends to a document, in particular an official document, comprising a base sheet, variable inscriptions associated with said base sheet and at least one protective device according to the invention.

An official document according to the invention may in particular be chosen from the group made up of passports, passport pages, customs cards, visas, identity cards, driver's licenses, vehicle registration cards (registration documents), bank cards, loyalty cards, bank checks, diplomas, certificates, transport documents, access control cards, badges, labels, legal writs, contracts, legal registers, cadastral maps, fiduciary documents, bank notes, and packagings and manufacturing drawings.

Advantageously and in a document according to the invention, at least one transparent film extends in contact with said adhesive layer.

Advantageously and according to the invention, said protective device covers at least one surface portion of said official document and extends according to a format suitable for the format of said surface portion.

Advantageously and according to the invention, said protective device extends according to a format similar to that of the document.

The invention also relates to a process for protecting a document, to a protective device and to a document, characterized in combination by all or some of the characteristics mentioned above or below.

### BRIEF DESCRIPTION OF THE DRAWINGS

Other objectives, characteristics and advantages of the invention emerge on reading the following description of one of the preferential embodiments thereof, given by way of nonlimiting example, and which refers to the appended figures in which:

FIG. 1 is a diagrammatic view of a first step of a process according to the invention in which a transparent film is represented in section,

FIG. 2 is a diagrammatic view of a second step of a process according to the invention in which a protective device according to the invention is represented in section,

FIG. 3 is a diagrammatic view of a third step of a process according to the invention in which a protective device and a document according to the invention are represented in section,

FIG. 4 is a diagrammatic view of a fourth step of a process according to the invention in which a protective device and a document according to the invention are represented in section,

FIG. 5 is a sectional diagrammatic view of a protective device obtained by means of a process according to the invention and bonded to an official document, and

FIG. 6 is a diagrammatic view of an official document protected by a protective device according to the invention.

### DETAILED DESCRIPTION

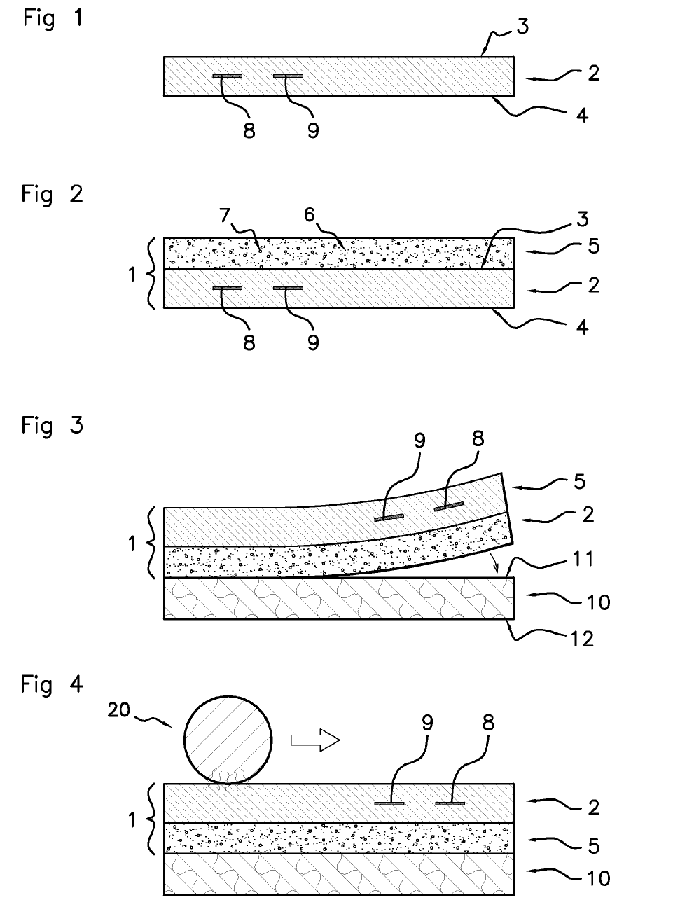

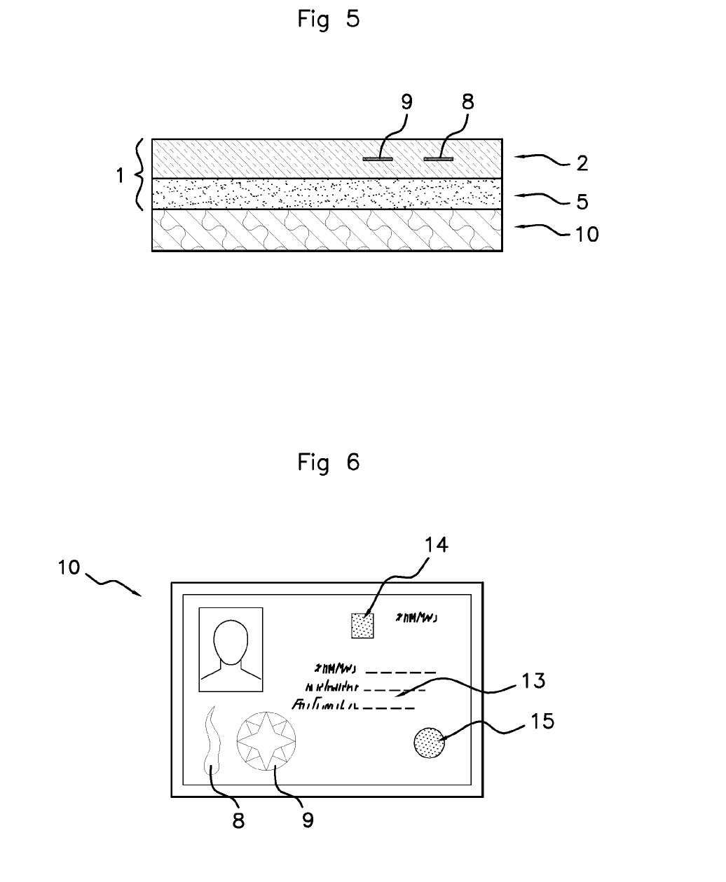

FIG. 1 represents a thin translucent or transparent film 2 made of polymer material, which acts as support film. The transparent film 2 is generally chosen so as to have a size substantially identical to that of the surface to be covered of the document to be protected. In one implementation variant, the transparent film 2 may also be chosen so as to have a size which exceeds that of the surface to be covered of the document to be protected.

The transparent film 2 can be formed of at least one layer of material chosen from thermosetting materials, and thermoplastic materials (in particular chosen from polycarbonates, PVCs, polyesters (polyethylene terephthalate PET, polyethylene terephthalate glycol PETG) and coextruded films of polyester and of polycarbonate (PEC), etc.). Other examples are possible.

The transparent film 2 may for example be formed of a stack of a plurality of layers superimposed on top of one another and having been subjected to hot lamination under pressure. The majority of the layers are preferably formed of a thermoplastic material, in particular chosen from polycarbonates, PVCs, polyesters (polyethylene terephthalate PET, polyethylene terephthalate glycol PETG), and coextruded films of polyester and of polycarbonate (PEC). In some advantageous embodiments, in particular for the applications of bank card, identification card or transport card type, the transparent film 2 is formed of a plurality of layers of polycarbonate. There is nothing to prevent the transparent film 2 from incorporating layers of different materials, including layers made of a material other than a thermoplastic material. The total number of layers constituting a protective device 1 according to the invention is not important within the context of the present invention. The transparent film 2 may also be a film of Fasprotek™ type (Fasver, Baillargues, France) or else a film of Fasfilm™ type (Fasver, Baillargues, France).

The transparent film 2 is in the general form of a sheet or a card and thus has two opposite external flat main faces, and a relatively small thickness. Throughout the remainder of the text, only one main face, termed extreme face 3, is described and has the characteristics of the invention, it being understood that the other extreme main face may just as easily have the same characteristics, or, on the contrary, have other characteristics. Consequently, it is assumed throughout the remainder of the text that the face opposite the extreme face 3 under consideration is an extreme main face of the transparent film 2 represented in section in FIG. 1, without this implying any limitation, such a transparent film 2 possibly itself consisting of a more or less thick layer or plurality of more or less thick layers, not described in the present description.

The transparent film 2 comprises security inscriptions 8, 9 such as inscriptions prepared using photoluminescent pigments (chosen from fluorescent pigments and phosphorescent pigments), reflective metalized inscriptions, etc.

FIG. 2 represents the transparent film 2 on which a thermoplastic polymeric adhesive layer 5 has been deposited. The adhesive layer 5 comprises at least one thermoplastic material and at least one compound, termed crosslinking agent 7, suitable for allowing crosslinking of said adhesive layer. As thermoplastic polymer, use may for example be made, in the adhesive layer, of:
copolyester resins having the references Dynapol L® and LH® from the company Evonik Degussa Corporation® (New Jersey, USA),
acrylic resins having the reference Neocryl® from the company DSM® (Zwolle, Holland),
cellulose-based resins such as those referenced CAB-551® from the company Eastman Chemical Company® (Kingsport, USA),
or else polyvinyl (butyral/acetal) resins having the reference S-LEC B/K® from the company Sekisui Chemical Company® (Dusseldorf, Germany).

As crosslinking agent, use may for example be made, in the adhesive layer, of:
curing agents of aliphatic polyisocyanate type, such as those referenced Desmodur® N 100®, N75®, N3200®, N3300®, N3390®, N3600®, N3790®, N3800®, XP2675®, E XP 2747®, XP2599®, E3265®, E3370®, Z4470®, XP2489®, XP2838®, XP2763® sold by the company Covestro® (Leverkusen, Germany),
curing agents of aliphatic polyisocyanate type which are blocked (that is to say the reactive functions of which become reactive starting from a predetermined temperature, for example about 150° C.), such as those referenced Trixene® BI7950®, BI7951®, BI7960®, BI7961®, BI7963®, BI7982®, BI791®, BI7992®, sold by the company Braxenden Chemicals Ltd® (Lancashire, United Kingdom), or referenced Desmodur® BL3175®, BL4265®, BL5375®, PL350®, PL340®, BL3370®, BL3475®, BL3272®, BL2078® sold by the company Covestro® (Leverkusen, Germany),
curing agents of polycarbodiimide type, such as those referenced Picassian® XL-701® and XL-725® from the company Stahl® (Waalwijk, the Netherlands),
curing agents of polyaziridine type, such as those referenced PZ-33® and PZ-28® sold by the company PolyAziridine LLC® (New Jersey, USA),
or else alkoxysilanes, such as those referenced A-186®, A-187®, A-link 25®, A-link 35® sold by the company Momentive® (New Jersey, USA).

The adhesive layer 5 deposited on the transparent film 2 comprises at least one thermoplastic material chosen from the group made up of polyurethanes (PUs), polyesters, polyacrylates, polyethers, polyvinyl butyrals, polyvinyl acetals, cellulose, copolymers thereof and blends thereof.

The crosslinking agent 7 is chosen from the group of aliphatic polyisocyanates. The adhesive layer comprises between 0.5% and 10%, —in particular between 1% and 5%, in particular between 2% and 4%—by weight of crosslinking agent.

The thickness of the adhesive layer 5 may be between 5 μm and 50 μm.

After having deposited the adhesive layer 5 at the surface of the transparent film 2, a protective device 1 according to the invention is obtained. A release film (not represented) can optionally be deposited at the surface of the adhesive layer 5 in order to protect the external surface of the adhesive layer before bonding thereof in contact with a document.

FIG. 3 represents the bonding of this protective device 1 to a document such as an official document 10 having an upper face 11 and a lower face 12. The protective device 1 is bonded to the upper face 11 of the official document 10.

Such an official document 10 may for example be chosen from the group made up of passports, passport pages, customs cards, visas, identity cards, driver's licenses, vehicle registration cards (registration documents), bank cards, loyalty cards, bank checks, diplomas, certificates, transport documents, access control cards, badges, labels, legal writs, contracts, legal registers, cadastral maps, fiduciary documents, bank notes, packagings and manufacturing drawings.

The official document 10 has various security markings 8, 9, 13, 14, 15 representing information (common information) and/or constituting security markings intended to reinforce the resistance to attempts at falsification and/or to prevent reproduction by optical reading.

After having deposited the protective device at the surface of a document, the crosslinking of the adhesive layer is activated. This can be carried out immediately after having affixed the protective device to the document, or subsequently if storage is required before final personalization of the document.

The crosslinking of the adhesive layer 5 is carried out by subjecting said adhesive layer to a temperature above a predetermined temperature for crosslinking the adhesive layer 5. The crosslinking of the adhesive layer 5 can also be carried out by carrying out at least one step of hot lamination, under pressure, of the document 10 coated with the previously prepared protective device 1.

FIG. 4 illustrates the step of hot lamination, under pressure, of the official document 10 comprising the protective device 1 by means of a lamination roll 20. The lamination roll 20 moves in contact with the extreme surface 4 of the transparent film 2 of the protective device 1 in a direction of movement defined by the arrow present in FIG. 4, so as to activate and to allow the crosslinking of the adhesive layer 5. FIG. 4 thus shows a transverse section of the lamination roll 20, the roll moving in a direction orthogonal to the longitudinal direction of the roll 20. The hot lamination under pressure can be carried out under the temperature and pressure conditions such that the temperature is between 60° C. and 220° C., and in particular between 80° C. and 200° C., and at a pressure of between 3×10⁵ Pa and 6×10⁵ Pa, the roll moving at a speed of 5 mm/s to 30 mm/s. In the context of a continuous manufacture, a single pass of the lamination roll over the surface of the official document may suffice. However, it is of course possible to provide for several successive passages of the lamination roll, in particular as a function of the other parameters (lamination temperature and pressure, respective natures and proportions of the thermoplastic material and of the crosslinking agent, thickness of the protective film, etc.).

Alternatively, the hot lamination under pressure may be carried out in a lamination press at temperatures of between 150 and 200° C. under a pressure of between 10×10⁵ Pa and 20×10⁵ Pa.

FIG. 6 represents an official document 10 (for example an identity card) onto which has been transferred the protective device as previously prepared. The official document 10 has various security markings 8, 9, 13, 14, 15, such as inscriptions prepared using photoluminescent pigments (chosen from fluorescent pigments and phosphorescent pigments), inscriptions prepared using iridescent pigments, reflective metalized inscriptions or else markings made by laser gravure.

The inventors have noted that a document protected according to the invention exhibits excellent resistance to handling and withstands detachment by successive flexing (in accordance with the standards applicable to official documents such as passports or identity cards in particular). The inventors have also noted that a document protected according to the invention exhibits excellent temperature resistance, in particular excellent climatic resistance (in particular during climatic resistance tests carried out between 35° C. and 70° C.). In addition, a protective device and a protected document according to the invention do not turn yellow over time.

### Example 1

A transparent polyester (PET) support film having a thickness of 100 μm, sold by the company Dupont Teijin Films™ (Tokyo, Japan) under the reference Melinex®, having been subjected to a heat and surface treatment of Politherm/Polibond® type carried out by the company Technifilm® (Valence, France), which may contain security printing for authentication, is chosen and a layer of adhesive in the format of the official document to be protected is printed thereon.

The adhesive layer is formed by printing on the above film an adhesive liquid composition by means of screen printing carried out using a fabric of which the mesh comprises 77 threads/cm having a diameter of 55 μm.

The adhesive composition is composed of:
30% by weight of a polyester thermoplastic resin having the reference Dynapol L210® sold by the company Evonik Degussa® Corporation (New Jersey, USA), having a concentration of between 25% and 30% by weight. This thermoplastic resin has a glass transition temperature of 63° C., a hydroxyl number, measured according to the standard DIN 53 240/2, of 5 mg KOH/g and a weight-average molecular weight, measured by size exclusion chromatography (SEC), of 20 000 g/mol,
1% by weight of a crosslinking agent having the reference Desmodur® N75 from the company Covestro (Leverkusen, Germany), each molecule of crosslinking agent containing 3 reactive isocyanate functions and 21 carbon atoms,
69% by weight of a solvent, ethyl 3-ethoxypropionate.

The transparent support film on which a layer of this adhesive composition has been deposited forms a protective device which is bonded to an official document to be protected, by lamination.

The official document comprises a sheet of synthetic paper sold under reference Teslin® (range SP1000®) by the company PPG Industries® (Ohio, USA). The sheet of Teslin® may contain a printed security background.

The lamination process is a roll process, the setpoint temperature of which is 150° C., the lamination of the official document being carried out at a speed of 17 mm/s under approximately 5×10⁵ Pa.

Following the bonding by lamination, heat activation for 5 min at 150° C. of the official document obtained makes it possible to finalize the crosslinking of the reactive functions of the thermoplastic resin with those of the crosslinking agent.

Example of protective device detachment resistance test:

The official document obtained is immersed for more than 72 hours in a bath of ethanol. The transparent film of the protective device does not detach from the official document.

The official document obtained is gradually heated on a hotplate, the temperature is gradually increased up to a temperature of 180° C. At each further increase of 2° C., an attempt is made to remove the transparent film from the protective device.

At no time does the transparent film of the protective device detach from the official document.

The invention may be the subject of a very large number of implementation variants. In particular, it is possible to prepare a protective device comprising two different adhesive layers, one adhesive layer being placed on each face of the transparent film. Alternatively, it is possible to place a transparent film according to the invention on each of the two faces of an official document in such a way as to protect each of the faces of said document against falsification.

1. A process for protecting a document, comprising:
bonding a transparent film to a face of said document with a view to protecting variable inscriptions of said document, by at least one adhesive layer comprising at least one thermoplastic polymer, wherein said thermoplastic polymer is chosen from the group made up of thermoplastic polymers having a hydroxyl number, measured according to the standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof,
wherein said thermoplastic polymer has a glass transition temperature, measured by differential scanning calorimetry, of between 40° C. and 110° C.,
wherein said adhesive layer also comprises at least one crosslinking agent, each crosslinking agent: being chosen from the group of aliphatic compounds comprising between 4 and 50 carbon atoms, having on average at least 2.8 functions, chosen from the group made up of isocyanates, carbodiimides, aziridines and alkoxysilanes, per molecule of crosslinking agent,
wherein, during the bonding of said transparent film to said document, crosslinking of said thermoplastic polymer and of said crosslinking agent of the adhesive layer is carried out.

2. The process as claimed in claim 1, wherein, prior to crosslinking of said thermoplastic polymer and of said crosslinking agent, said adhesive layer comprises 0.5% to 10% by weight of crosslinking agent relative to the total weight of said thermoplastic polymer.

3. The process as claimed in claim 1, wherein said crosslinking of said adhesive layer is carried out at a temperature of between 60° C. and 220° C.

4. The process as claimed in claim 1, further comprising hot laminating, under pressure, said document coated with said transparent film.

5. The process as claimed in claim 1, wherein said thermoplastic polymer is chosen from the group of thermoplastic polymers having, before said crosslinking, a weight-average molecular weight, measured by size exclusion chromatography, of between 3000 g/mol and 65 000 g/mol.

6. A protective device for a document having variable inscriptions to be protected, said protective device comprising:
at least one transparent film bearing at least one adhesive layer comprising at least one thermoplastic polymer,
wherein said thermoplastic polymer is chosen from the group made up of thermoplastic polymers having a hydroxyl number, measured according to the standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof,
wherein said thermoplastic polymer has a glass transition temperature, measured by differential scanning calorimetry, between 40° C. and 110° C., and
wherein adhesive layer also comprises at least one crosslinking agent, each crosslinking agent chosen from the group of aliphatic compounds comprising between 4 and 50 carbon atoms, having on average at least 2.8 functions, chosen from the group made up of isocyanates, carbodiimides, aziridines and alkoxysilanes, per molecule of crosslinking agent.

7. The device as claimed in claim 6, wherein said adhesive layer comprises between 0.5% and 10% by weight of crosslinking agent relative to the total weight of said thermoplastic polymer.

8. The device as claimed in claim 6, wherein said transparent film comprises a plurality of superimposed layers.

9. The device as claimed in claim 6, wherein said transparent film comprises at least one layer, in particular at least one thermoplastic extreme layer.

10. The device as claimed in claim 6, wherein said thermoplastic polymer is chosen from the group made up of thermoplastic polymers having a weight-average molecular weight, measured by size exclusion chromatography, of between 3000 g/mol and 65 000 g/mol.

11. The device as claimed in claim 6, wherein said adhesive layer comprises at least one thermoplastic material chosen from the group made up of polyurethanes, polyesters, polyacrylics, polyethers, polyvinyl butyrals, polyvinyl acetals, cellulose, copolymers thereof and blends thereof.

12. A document comprising:
a base sheet;
variable inscriptions associated with said base sheet; and
at least one adhesive layer comprising at least one thermoplastic polymer, said adhesive layer extending in contact with an extreme layer of said base sheet,
wherein said thermoplastic polymer is chosen from the group made up of thermoplastic polymers having a hydroxyl number, measured according to standard DIN 53 240/2, of between 3 mg of KOH/g and 60 mg of KOH/g, thermoplastic polymers having an acid number, measured according to the standard DIN EN ISO 2114, of between 2 mg of KOH/g and 150 mg of KOH/g, copolymers thereof and blends thereof,
wherein said thermoplastic polymer has a glass transition temperature, measured by differential scanning calorimetry, of between 40° C. and 110° C., and
wherein said adhesive layer also comprises at least one crosslinking agent, each crosslinking agent: being chosen from the group of aliphatic compounds comprising between 4 and 50 carbon atoms, having on average at least 2.8 functions, chosen from the group made up of isocyanates, carbodiimides, aziridines and alkoxysilanes, per molecule of crosslinking agent.

13. The document as claimed in claim 12, wherein at least one transparent film extends in contact with said adhesive layer.
